(19) United States
(12) Patent Application Publication
(10) Pub. No.: US 2008/0246989 A1
(43) Pub. Date: Oct. 9, 2008

(54) IMAGE FORMING APPARATUS

(76) Inventor: Shigeo KONUMA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/868,248

(22) Filed: Oct. 5, 2007

(30) Foreign Application Priority Data
Apr. 6, 2007 (JP) JP2007-100765

(51) Int. Cl. G06K 15/00

(52) U.S. Cl. 358/1.15

(57) ABSTRACT

There is described an image forming apparatus, which makes it possible to confirm setting contents of the job in a state that the job list is still displayed. The image forming apparatus includes: a job storage section to store job information including setting contents of the job in it; a display section to display a screen in which a first area and a second area are disposed in such a manner that those do not overlap with each other; and a control section to control contents to be displayed within the screen by the display section. The control section controls the display section, so that a job list based on the job information is displayed on the first area, and, at the same time, the setting contents of a specific job selected from the job list are displayed on the second area in parallel to the job list.

This application is based on Japanese Patent Application NO. 2007-100765 filed on Apr. 6, 2007 with Japan Patent Office, the entire content of which is hereby incorporated by reference.

### BACKGROUND OF THE INVENTION

The present invention relates to an image forming apparatus, which is capable of displaying a job list.

There has been in the market an image forming apparatus, such as a copier, etc., provided with a reserving function, which allows the user to input a reservation of next job as a reserved job before an output operation of the preceding job is completed. Further, as shown in FIG. 7, a certain image forming apparatus is provided with not only the reserving function, but also a displaying function, which make it possible to display a job list 501, indicating job numbers and statuses of output waiting jobs, a number of paper sheet to be printed, a time required, etc., on a job management screen 500. The user can employ the job list 501 for confirming the statuses of the output waiting jobs, for selecting a specific job to be pending from the jobs listed in the job list 501 as needed, for deleting a specific job, for changing the priority order of the jobs concerned, etc.

To appropriately make such the decisions as mentioned in the above, sometimes, the information displayed on the job list are insufficient. Accordingly, a detail button 502a is disposed within the job management screen 500, so that the current screen is shifted to a separate screen indicating the detailed information with respect to the job currently selected or a separate popup screen emerges, when the user operates the detail button 502a (for instance, set forth in Patent Document 1 (Tokkaihei 8-307583, Japanese Non-Examined Patent Publication)).

In the typical image forming apparatus, since the size of the display screen tends to be limited to smaller dimensions, due to the limitation of the apparatus cost, the limitation of the panel layout, etc., it is difficult to drastically increase the information amount to be displayed on the job list. Further, in the configuration in which the current screen is shifted to a separate screen indicating the detailed information of the job selected from the jobs included in the job list, the user should conduct the operation for displaying the separate screen, and then, the operation for returning to the original screen, every time when the user wishes to confirm the detailed information. Accordingly, there has been a problem that the above-mentioned operations are very cumbersome for the user, and it has been impossible for the user to swiftly conduct the operations concerned.

Further, in the conventional image forming apparatus, the user should conduct the operation for shifting the current screen to the separate screen, even when he wishes to change only a part of setting contents in regard to the job selected from the jobs included in the job list.

### SUMMARY OF THE INVENTION

To overcome the abovementioned drawbacks in conventional image forming apparatus, it is one of objects of the present invention to provide an image forming apparatus, which makes it possible to confirm setting contents of the job in a state that the job list is still displayed, while, it is another one of objects of the present invention to provide an image forming apparatus, which makes it possible to change operations or setting contents with respect to the job from a screen currently displaying the job list.

Accordingly, at least one of the objects of the present invention can be attained by the image forming apparatus described as follow.

(1) According to an image forming apparatus reflecting an aspect of the present invention, the image forming apparatus that executes a job to form an image, comprises: a job storage section to store job information including setting contents of the job in it; a display section to display a screen in which a first area and a second area are disposed in such a manner that the first area and the second area do not overlap with each other; and a control section to control contents to be displayed within the screen by the display section; wherein the control section controls the display section, so that a job list based on the job information stored in the job storage section is displayed on the first area, and, at the same time, the setting contents of a specific job selected from the job list are displayed on the second area in parallel to the job list.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic block diagram of an image forming apparatus, embodied in the present invention;

FIG. 2 shows an example of a copy setting screen to be displayed on an operating display section of an image forming apparatus, embodied in the present invention;

FIG. 3 shows an example of a job list screen to be displayed on an operating display section of an image forming apparatus, embodied in the present invention, at a time of a job non-selected state;

FIG. 4 shows an example of a job list screen to be displayed on an operating display section of an image forming apparatus, embodied in the present invention, at a time of a job selected state;

FIG. 5 shows an example of a job list screen to be displayed on an operating display section of an image forming apparatus, embodied in the present invention, indicating such a state that a release confirming popup screen overlaps the job list screen shown in FIG. 4;

FIG. 6 shows a flowchart indicating processing to be conducted by a control CPU with respect to a displaying operation of a job list screen; and

FIG. 7 shows an explanatory drawing indicating a conventional job management screen within which a job list is displayed.

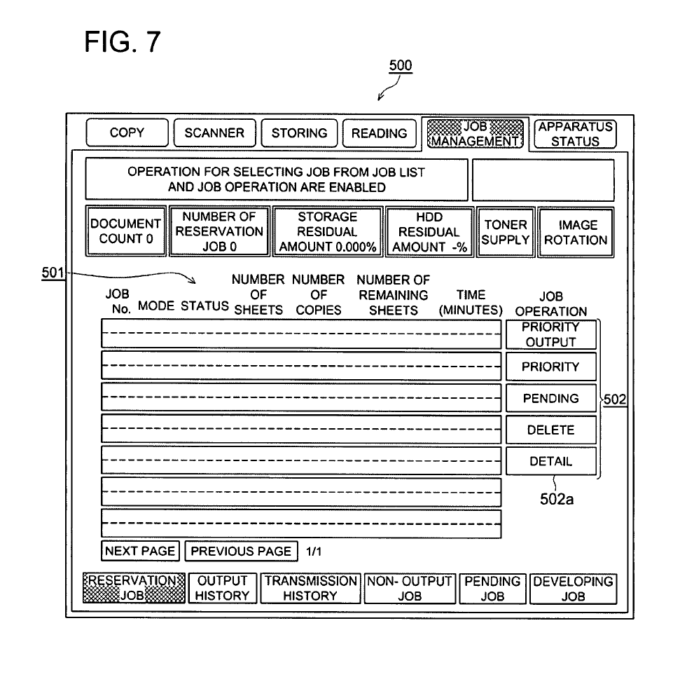

### DETAILED DESCRIPTION OF THE PREFERRED EMBODIMENT

Referring to the drawings, an image forming apparatus, embodied in the present invention, will be detailed in the following.

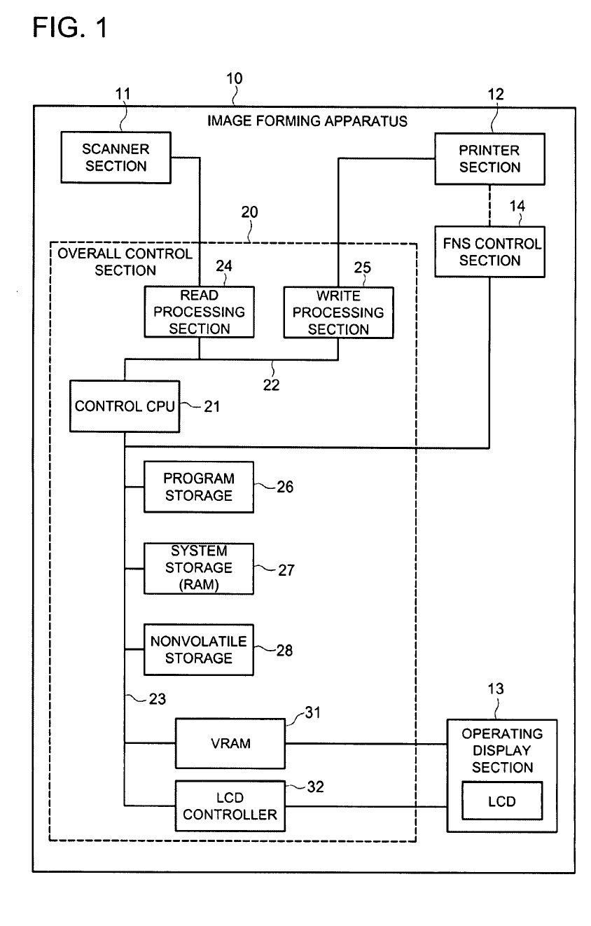

FIG. 1 shows a schematic block diagram of an image forming apparatus 10, embodied in the present invention. The image forming apparatus 10 is structured as a multi-functional apparatus (or a compound image forming apparatus), which is provided with a copy function for printing an image acquired by opt-electronically reading an original document onto a recording medium so as to output the recording medium with the printed image, a scanning function for outputting image data acquired by opt-electronically reading an original document to an external apparatus, a storing function for storing the image data acquired in the above, a printer function, etc.

The image forming apparatus 10 is constituted by an overall control section 20, a scanner section 11, a printer section 12, an operating display section 13 serving as an interface with the user, and a FNS (FiNiSher) control section 14, which are coupled to the overall control section 20. Sometimes, a post processing apparatus (not shown in the drawings) that applies various kinds of post processing, such as a folding operation, a binding operation, a punching operation, etc., to the recording medium outputted from the printer section 12, is coupled to the output portion of the printer section 12. On that occasion, the FNS control section 14 controls the post processing apparatus (also called a finisher).

The scanner section 11 acquires the image data by opt-electronically reading the original document. The scanner section 11 is provided with a light source to emit light for irradiating the original document, a line image sensor to read the original document in its width direction in a unit of one horizontal line, a conveyance mechanism to move the reading position of the line image sensor in the longitudinal direction of the original document in a unit of one horizontal line and an optical path including lenses and mirrors to introduce the light reflected from the original document into the line image sensor, so as to focus the light onto the line image sensor.

The printer section 12 prints an image represented by the image data onto the recording medium. In this embodiment, the printer section 12 is configured as a laser printer that forms the image through the electro-photographic image forming process, and accordingly, is provided with a conveyance mechanism of the recording medium, a photoreceptor drum, a charging device, a laser unit, a developing device, a transferring separation device, a cleaning device and a fixing device.

The operating display section 13 is constituted by a LCD (Liquid Crystal Display) serving as a display device on the surface of which a touch panel is mounted, and various kinds of operation switches, such as a start button, etc., so as to display various kinds of operating screens and guiding screens, and to accept various kinds of operations conducted by the user. The image forming apparatus 10 accepts various kinds of setting operations with respect to the job, a job introducing operation, etc., inputted by the user through the operating display section 13. The various kinds of jobs include a copy job for copying the original document, a print job for conducting a printing operation based on print data, etc.

The overall control section 20 is provided with a control CPU (Central Processing Unit) 21 for control use, serving as a control section to totally control the operations to be conducted in the image forming apparatus 10. The control CPU 21 is coupled to both an image bus 22 and a system bus 23, which are independent relative to each other.

Both a read processing section 24 and a write processing section 25 are coupled to the image bus 22. The read processing section 24 is such an electric circuit that applies various kinds of image processing, such as a shading correction/a luminance to density conversion, a density γ conversion, an error diffusion processing, etc., one by one to the image data inputted from the scanner section 11. On the other hand, the write processing section 25 is such an electric circuit that applies various kinds of image processing, such as a cell average processing, a resolution conversion, a printer γ conversion, a micro-variable power processing, a screen processing, etc., to the image data to be outputted to the printer section 12.

A program storage 26, a system storage 27, a nonvolatile storage 28, a VRAM (Video Random Access Memory) 31 serving as a display memory plane and a LCD (Liquid Crystal Display) controller 32 are coupled to the system bus 23. The program storage 26 stores programs to be executed by the control CPU 21. The system storage 27 serves as a working memory and/or an image data memory for temporarily storing various kinds of data when the control CPU 21 executes the programs concerned.

The nonvolatile storage 28 stores user information, such as a name of user, a password, etc., job information representing properties of the job concerned, such as contents of the job setting, an owner of the job, etc., various kinds of other data to be reserved even if the power of the apparatus is turned OFF (for instance, a counter value indicating a frequency of usages), etc.

The VRAM 31 serves as a memory plane to store the image data representing the screen image to be displayed on the LCD of the operating display section 13. The LCD controller 32 conducts the controlling operations for displaying the screen image based on the image data stored in the VRAM 31 on the LCD of the operating display section 13.

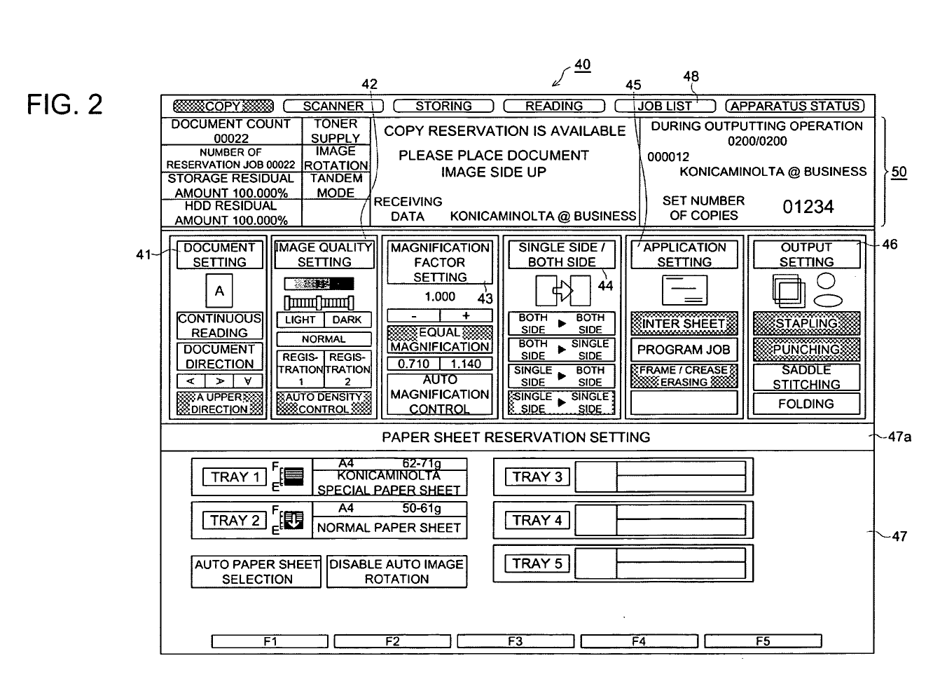

FIG. 2 shows an example of a copy setting screen 40 on which various kinds of setting operations with respect to the copy job are conducted. At an upper position of the copy setting screen 40, a fundamental items display area 50 for indicating fundamental items in respect to a current status of the image forming apparatus 10 is disposed. In the copy setting screen 40, various kinds of setting areas, such as a document setting area 41, an image quality setting area 42, a magnification factor setting area 43, a one-side/both-side setting area 44, an application setting area 45, an output setting area 46, a paper sheet setting area 47, are disposed at a space located below the fundamental items display area 50. In each of the above setting areas, not only guiding information and buttons for setting the corresponding item are displayed, but also the contents of current setting status in regard to each of the setting items are displayed.

For instance, in the document setting area 41, the user can establish a method for reading the original document (continuous or incremental) and/or a direction of the original document to be set onto the scanner section 11. In the example shown in FIG. 2, the method for reading the original document is set at “CONTINUOUS READING”, while the direction of the original document is set at “UPPER DIRECTION”. With respect to the application setting, an “INTER SHEET” function and a “FRAME/CREASE ERASING” function are turned ON. The inter sheet function enables the post processing apparatus to insert a separate sheet between the recording mediums outputted from the printer section 12. The frame/crease erasing function is defined as such a function that replaces a circumferential edge portion of the image data read from the original document and/or image data at a folded portion, such as two fold, etc., with white image data representing a white color solid image, so as to erase an unnecessary image, such as a shadow image, etc.

With respect to the output setting, a post processing function for stapling a bunch of the recording mediums outputted from the printer section 12, and another post processing function for punching the bunch of the recording mediums are turned ON. With respect to the paper sheet reservation setting, it is established that the recording mediums to be used in the job concerned are fed from a tray 1. Further, in the paper sheet reservation setting area, a size, a kind of paper, a basis weight, a residual amount, etc. of the paper sheets accommodated in each of the trays 1-5 are displayed. In this connection, the image forming apparatus 10 is so constituted that, by operating a paper sheet reservation setting button 47a, an imaginary state in which arbitral kind of paper sheets, being different from the paper sheets currently accommodated, are accommodated in any one of the trays can be established, in order to select a suitable tray to be employed for the image output operation from the provided trays.

The setting contents of each of the setting items, established by using the copy setting screen 40, etc., are stored into the nonvolatile storage 28 as a part of job information of the job concerned. In this connection, the job information includes a user name of the user who introduce the job concerned, a mode indicating a kind of the job (such as a print job, a copy job, etc.), a file name of the print data of the printing object in the case of the print job, a status of the job (such as an outputting phase, a reserving phase, a pending phase, etc.), a number of paper sheets, a number of prints, a number of residual paper sheets until completion of the printing operation, information for indicating a time period required for implementing the job, etc.

The image forming apparatus 10 is so constituted that a next job can be introduced as a reservation job before the implementation of the current job previously introduced is completed. The copy operation is conducted as a combination of the inputting operation for once storing the image data, acquired by reading the original document in the scanner section 11, into storage, and the outputting operation for reading out the image data from the above storage so as to output the image data from the printer section 12. Accordingly, if the scanner section 11 enters into a standby state after the inputting operation is completed, it is possible to introduce the next job by reading an original document of the nest job in the scanner section 11 so as to store image data of the next job into the storage, during the time interval when the printer section 12 implements the output operation in regard to the current job concerned. For instance, even in such the case that plural copies (for instance, 100 copies) should be produced, it becomes possible to introduce a large number of reservation jobs while the output operations of them are currently implemented.

Further, with respect to the print job, it is possible to accept new print jobs one by one as the reservation jobs from an external terminal device, such as a personal computer, etc., during the output operation of the other job.

The image forming apparatus 10 is so constituted that a job queue, which is formed by aligning jobs, whose output operations are uncompleted among the introduced jobs, in order of output priorities of them, is created and stored into the nonvolatile storage 28, so as to implement the output operations of the uncompleted jobs one by one according to order of the job queue. In this connection, each of the jobs included in the job queue is correlated to the job information of the corresponding job. Based on the job queue and the job information, the control CPU 21 makes the operating display section 13 display the job list and the setting contents of the job concerned, detailed later.

Next, the job list will be detailed in the following.

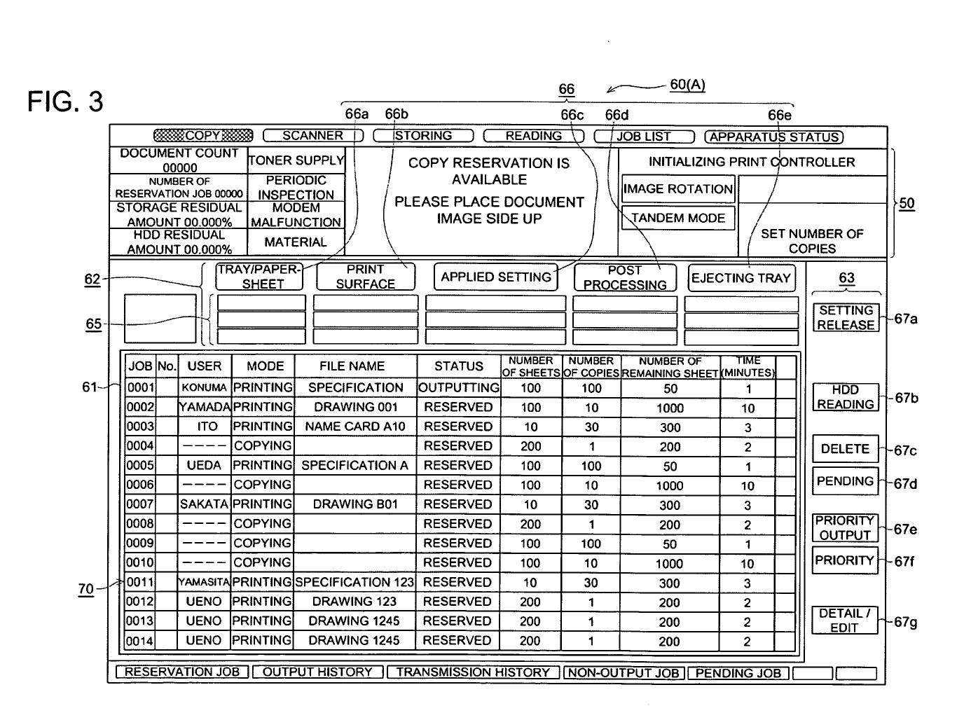

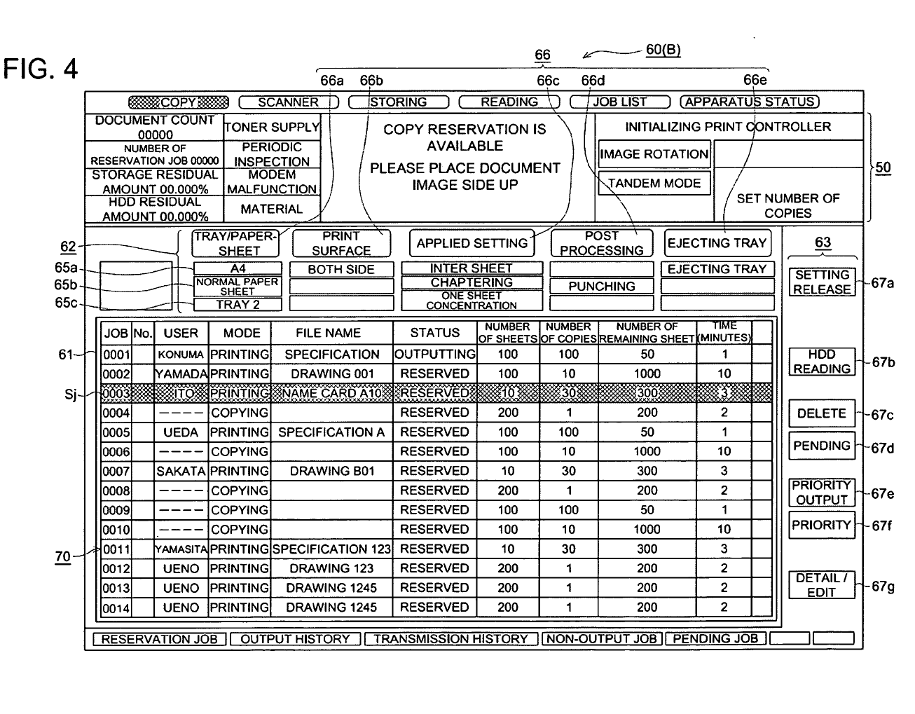

FIG. 3 and FIG. 4 respectively show a job list screen 60 to be displayed on the operating display section 13. The job list screen 60 is displayed on the screen, when the user selects a job list tag 48 located a right-upper position of the copy setting screen 40 shown in FIG. 2. In this connection, the image forming apparatus 10 is so constituted that, when the user touches a concerned position or the operating button residing on the screen currently displayed among the various kinds of screens to be displayed on the operating display section 13, an operation or a selection corresponding to the concerned position or the operating button is accepted.

As well as the copy setting screen 40, the fundamental items display area 50 is disposed at an upper position of the job list screen 60. The job list screen 60 includes a first area 61 on which a job list 70 is displayed, a second area 62 on which setting contents with respect to a specific job selected from the job list 70 by the user (hereinafter, referred to as a selected job Sj) are displayed item by item, and a third area 63 on which various kinds of operating buttons are aligned, and those areas are formed as separate areas without overlapping with each other.

The job list screen 60(A), shown in FIG. 3, indicates a state in which no job is selected form the job list 70 displayed on the first area 61 by the user (non-selected state), while the job list screen 60(B), shown in FIG. 4, indicates another state in which a specific one of jobs included in the job list 70 is selected by the user (selected state).

In the job list 70 displayed on the first area 61, the information, indicating a job number, a user name of the user who introduce the job concerned, a mode indicating a kind of the job, a file name of the print data of the printing object in the case of the print job, a status of the job (such as an outputting phase, a reserving phase, a pending phase, etc.), a number of paper sheets, a number of prints, a number of residual paper sheets until completion of the printing operation, information for indicating a time period required for implementing the job, are serially displayed in a horizontal one line for every job.

As shown in FIG. 4, on the second area 62, not only the setting contents with respect to the selected job Sj selected from the job list 70 displayed on the first area 61 are displayed item by item, but also plural display operating buttons 65, each of which is provided with a function of a corresponding operating button, are disposed. The plural display operating buttons 65 are displayed by classifying them into plural groups, and titles 66 are displayed in such a manner that a position of each title corresponds to each of the plural groups.

In the job list screen 60(B) shown in FIG. 4, a setting item group in regard to the tray/paper-sheet, another setting item group in regard to the print surface, still another setting item group in regard to the applied setting, still another setting item group in regard to the post processing and yet another setting item group in regard to the ejecting tray are displayed. Titles 66a-66e corresponding to the abovementioned groups, namely, a tray/paper-sheet title 66a, a print surface title 66b, an applied setting title 66c, a post processing title 66d and an ejecting tray title 66e, are serially aligned in a horizontal one line at an upper space of the second area 62, and each group of the plural display operating buttons 65, which correspond to each of the titles, is disposed below the corresponding title.

For instance, in the job list screen 60(B) shown in FIG. 4, a paper sheet size button 65a indicating a size of the output paper sheet, a paper kind button 65b indicating a kind of the output paper sheet and a tray button 65c indicating a number of the paper sheet feeding tray of the output paper sheet, are aligned in a vertical direction and disposed below the tray/paper-sheet title 66a as a set of the plural display operating buttons 65 belonging to the tray/paper-sheet group. In this example, since an “A4” is displayed on the paper sheet size button 65a, it is indicated that the paper size is set at “A4”. Further, since a “NORMAL PAPER” is displayed on the paper kind button 65b, it is indicated that the paper kind is set at “NORMAL PAPER”. Still further, since a “TRAY 2” is displayed on the tray button 65c, it is indicated that the paper sheet feeding tray is set at “TRAY 2”.

As shown in FIG. 3, in the non-selected state in which no job is selected, no sign is displayed on each of the plural display operating buttons 65. When the user selects one of the jobs from the job list 70 displayed on the first area 61 as a selected job Sj, each of setting contents of the setting items in regard to the selected job Sj is displayed on corresponding one of the plural display operating buttons 65 displayed on the second area 62. In addition, as for the displaying operation of the job list 70, the displaying mode of the selected job Sj is turned to another mode, which is different from that for the other jobs, for instance, a mode in which the horizontal one line corresponding to the selected job Sj turns to an inverse color, etc. The screen shown in FIG. 4 indicates such a state that the user selected the selected job Sj having job number “0003”, and the line of job number “0003” is displayed in an identifiable mode within the job list 70, and further, the setting contents of the job concerned are also displayed on the second area 62.

In this connection, when the user touches a concerned position in the job list 70, the job displayed at the touched position can be selected. Further, in the state that a certain job is already selected, when the user touches another position corresponding to another job within the job list 70, the currently touched job is newly selected as the selected job Sj instead of the certain job previously selected, and further, contents displayed on the second area 62 are also changed corresponding to the setting contents of the selected job Sj newly selected.

Various kinds of operating buttons 67, including a setting release button 67a, an HDD reading button 67b, a delete button 67c, a pending button 67d, a priority output button 67e, a priority button 67f and a detail/edit button 67g, are aligned in the third area 63.

When any one of the operating buttons 67 is operated in the state that a specific job is selected, the control CPU 21 applies a processing corresponding to the operated one of the operating buttons 67 to the specific job currently selected.

Concretely speaking, when the setting release button 67a is operated, the control CPU 21 cancels all of the setting contents currently established with respect to the job whose setting contents are displayed on the second area 62, in order to change them to the default values. Further, when the delete button 67c is operated, the control CPU 21 deletes the job currently selected.

Still further, when the pending button 67d is operated, the control CPU 21 changes the state of the job currently selected to the pending state. For instance, the method of making the job enter into the pending state is to change the job status information to the pending state while the concerned job is included into the job queue. In this case, the control CPU 21 skips the job, the status information of which is set at the pending state, when the control CPU 21 retrieves a job, to be implemented next, from the top of the job queue. Further, it is also applicable that the job to be pending is excluded once from the job queue.

Still further, when the priority output button 67e is operated, the control CPU 21 shifts the priority order of the job, currently selected, to the highest order. Still further, when the priority output button 67e is operated, the control CPU 21 makes the priority order of the job, currently selected, arbitrarily changeable, and enters into a state of accepting the priority order changing operation, which can be conducted by changing the order of the jobs within the job queue.

Still further, when the detail/edit button 67g is operated, the control CPU 21 displays a popup screen (not shown in the drawings) for changing the various setting contents with respect to the job concerned. For instance, an operating screen, which is similar to the copy setting screen 40 shown in FIG. 2 and from which the setting contents are changeable, is displayed as the popup screen.

When any one of the plural display operating buttons 65 is selected in the state that the setting contents of the selected job Sj are displayed on the second area 62, the image forming apparatus 10 enters into a state of accepting the operation for changing the setting contents of the setting item corresponding to the selected one of the plural display operating buttons 65.

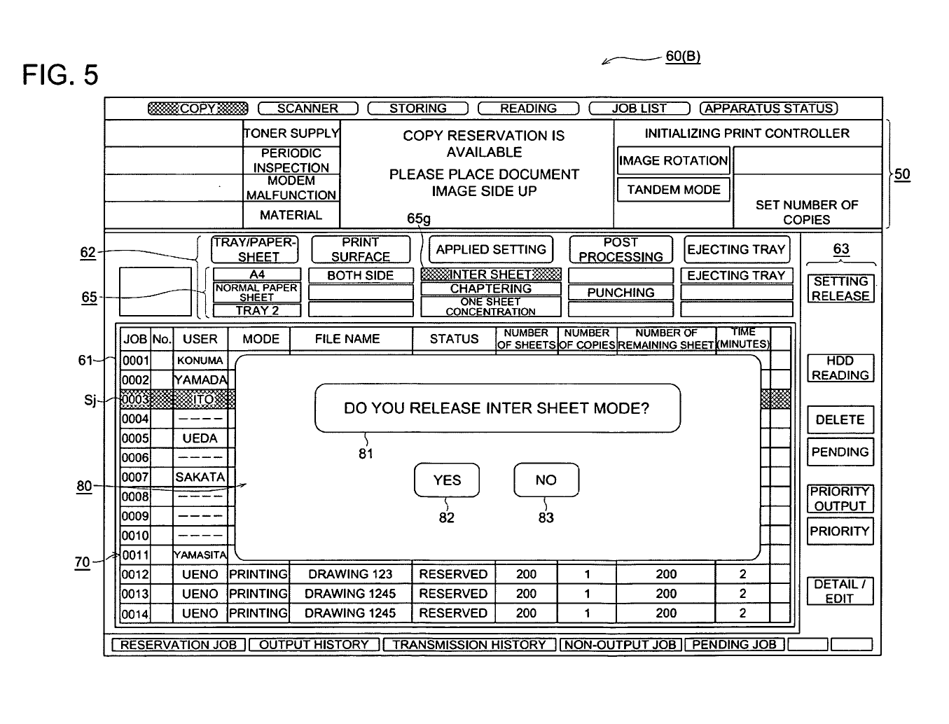

As shown in FIG. 5, for instance, when an inter sheet button 65g included in the applied setting group is selected, a release confirming screen 80, for inquiring whether or not setting contents in regard to the inter sheet is released, is displayed as a popup screen, in such a manner that the popup screen overrides the job list 70 currently displayed on the first area 61. In the release confirming screen 80 exemplified in FIG. 5, a message 81 indicating a content to be released, a “YES” button 82 and a “NO” button 83 are displayed within the popup screen. If the user selects the “YES” button 82, the setting contents in regard to the inter sheet is released and the release confirming screen 80 is closed (disappears). While, if the user selects the “NO” button 83, the setting contents in regard to the inter sheet is not released and the release confirming screen 80 is closed (disappears).

The changing operation with respect to the setting contents indicated by the one of the plural display operating buttons 65, selected in the second area 62, is not limited to the releasing operation. For instance, it is also applicable that the setting change screen with respect to the setting item corresponding to the selected one of the plural display operating buttons 65 is displayed as the popup screen, so as to accept a request of the setting change with respect to the setting item concerned. For instance, it is applicable that, when the tray button 65c is selected, a tray selecting screen (not shown in the drawings) in which changeable candidate trays are listed is displayed as the popup screen.

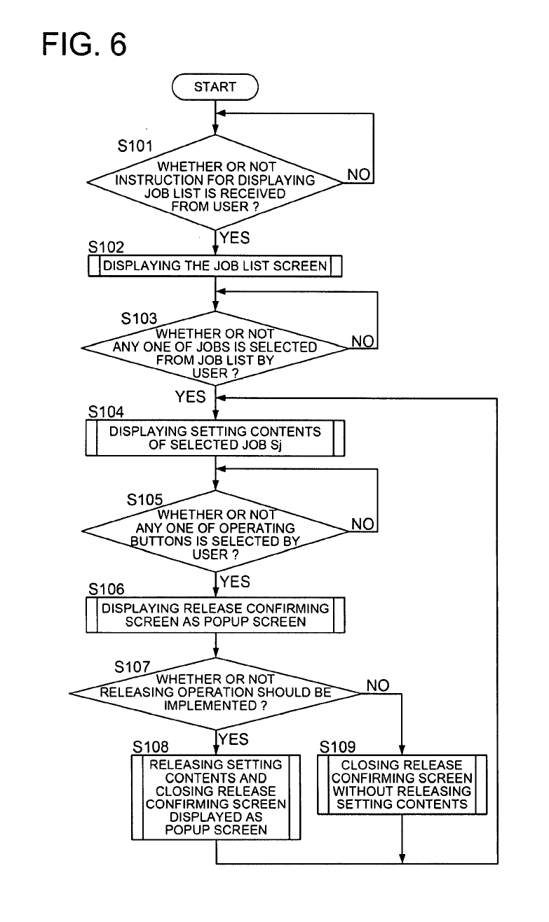

FIG. 6 shows a flowchart indicating the processing to be conducted by the control CPU 21 with respect to the displaying operation of the job list screen 60. The flowchart of the processing to be conducted by the control CPU 21 includes the steps of: receiving instruction for displaying the job list 70 from the user (for instance, a job list tag 48 is selected in the copy setting screen 40) (Step S101; YES); creating the job list 70 based on the job queue and the job information stored in the nonvolatile storage 28, so as to make the operating display section 13 display the job list screen 60(A), which includes the job list 70 and is in the non-selected state (Step S102); and when the user select any one of the jobs from the job list 70 in the job list screen 60(A) (Step S103; YES), displaying the job list screen 60(B), which is in the selected state, with respect to the job concerned (Step S102, refer to FIG. 4). Concretely speaking, the control CPU 21 displays one of the plural display operating buttons 65, indicating the setting contents of the selected job Sj, and changes the color of the selected job Sj to the inverse color or the like, so as to display it in an identifiable mode from the other jobs.

The flowchart of the processing to be conducted by the control CPU 21, shown in FIG. 6, further includes the steps of: when the user select any one of the plural display operating buttons 65 displayed on the second area 62 in the job list screen 60(B), which is in the selected state (Step S105; YES), entering into a state of accepting the changing operation with respect to the setting contents indicated by the selected one of the plural display operating buttons 65, namely, displaying the release confirming screen for releasing the current setting contents (for instance, the release confirming screen 80 shown in FIG. 5, since the flowchart shown in FIG. 6 exemplifies the case of releasing the current setting contents) as the popup screen (Step S106); when receiving the operation for instructing the release of the setting contents, conducted by the user on the release confirming screen (for instance, operating the “YES” button 82 shown in FIG. 5) (Step S107; YES), releasing the setting contents in regard to the setting item concerned, and then, closing the release confirming screen currently displayed as the popup screen (Step S108), to return to Step S104; and when receiving the instruction of canceling the release of the setting contents, conducted by the user on the release confirming screen (for instance, operating the “NO” button 83 shown in FIG. 5) (Step S107; NO), closing the release confirming screen currently displayed as the popup screen (Step S109), to return to Step S104.

In this connection, if any one of the operating buttons 67 residing in the third area 63 is operated in the state that the setting contents of one of the jobs, selected from the job list 70, are displayed on the second area 62, the operation corresponding to the above selected one of the operating buttons 67 is conducted for the job (selected job Sj) whose setting contents are displayed on the second area 62, though not shown in FIG. 6. If the user selects a new job from the jobs listed in the job list 70 in the state that the other job is already selected, the new job acquires the position of the selected job Sj instead of the other job, and the setting contents of the new job are displayed on the second area 62, though not shown in FIG. 6.

As described in the foregoing, since both the first area 61 and the second area 62, which are formed as separate areas without overlapping with each other, are disposed in the job list screen 60, in such a manner that the job list 70 is displayed within the first area 61, so as to accept the job selecting operation in the job list 70, and the setting contents of the selected job are displayed on the second area 62, it becomes possible for the user to easily confirm the setting contents of the specific job selected from the jobs listed in the job list 70, while maintaining the state that the job list 70 is still displayed. Accordingly, it becomes unnecessary for the user to open a separate screen for confirming the setting contents of the job concerned, and therefore, it becomes possible not only to alleviate user's operating burden, but also to swiftly confirm the setting contents of each of the job.

Further, according to the present invention, it is possible to conduct various kinds of operations, such as the deleting operation, the pending operation, the priority order changing operation, etc., to be applied to the selected job Sj, the setting contents of which are displayed on the second area 62, from the operating buttons 67 displayed on the third area 63 residing within the same screen. Accordingly, the consecutive operation, including such the steps of; confirming the setting contents of each of the jobs; then, retrieving a desired job; and applying the operation, such as the deleting operation, the pending operation, the priority order changing operation, etc., to the retrieved job, can be implemented only on the job list screen 60 without shifting to other screens, resulting in a security of high level maneuverability and convenience.

For instance, in such the case that the setting contents of each of the jobs are confirmed on the indications of the second area 62 by sequentially selecting each of the jobs displayed on the job list 70, and, as a result of the above confirming operation, it is revealed that the output paper sheets established in the preceding job are not loaded in the paper sheet feeding tray, it becomes possible to directly conduct the operation, such as making the concerned job pending, deleting the job concerned, lowering the priority order of the job concerned, or heightening the priority order of the following job for which the necessary paper sheets are already loaded in the paper sheet feeding tray, from the job list screen 60, and as a result, extremely high level maneuverability and convenience can be provided. Accordingly, it becomes easy to conduct the operation for changing the job status, so that the job, for which the paper sheets are already loaded in the paper sheet feeding tray, is implemented with precedence, and it is possible to heighten the operating efficiency of the apparatus, compared to such the case that the paper sheets accommodated in the paper sheet feeding tray are changed at a transition point from a job to another job.

Further, by selecting one of the plural display operating buttons 65, on which setting contents are displayed for every setting item, it becomes possible to conduct the changing operation with respect to the setting contents of the setting item corresponding to the selected one of the plural display operating buttons 65 (for instance, the operation for releasing the setting contents). Accordingly, it also becomes possible to directly conduct the changing operation in a unit of setting item from the job list screen 60. In other words, when the user finds out a specific setting item for which the operation for releasing or changing the setting contents is necessary, as a result of confirming the setting contents of each setting item of the selected job by observing the contents displayed on the plural display operating buttons 65, the user can conduct the operation for releasing or changing the setting contents with respect to the setting item concerned, only by operating one of the plural display operating buttons 65, which corresponds to the setting item concerned.

Although the embodiment of the present invention has been detailed in the foregoing, referring to the drawings, the scope of the present invention is not limited to the aforementioned embodiment. Any kinds of modifications and additions made by a skilled person without departing from the spirit and scope of the invention shall be included in the present invention.

For instance, since the screen layout of the job list screen 60 indicated in the aforementioned embodiment is merely one of various examples, the scope of the sizes and the layouts of the first area 61, the second area 62 and the third area 63 are not limited to those indicated in the job list screen 60 exemplified in the aforementioned embodiment, as far as those are disposed in such a manner that those do not overlap with each other.

Further, the scope of items displayed on the job list 70 and the scope of the setting items indicated in the second area 62 are not limited to those indicated in the embodiment. It is applicable that those are changeable as needed.

According to the image forming apparatus embodied in the present invention, since the job list and the setting contents of the specific job selected from the job list are displayed in parallel on the separate areas in such a manner that those do not overlap with each other, it is unnecessary to open a separate screen for confirming the setting contents of the specific job selected from the job list. According to the above, it becomes possible not only to swiftly confirm the setting contents of each of the job, but also to alleviate user's operating burden.

While the preferred embodiments of the present invention have been described using specific term, such description is for illustrative purpose only, and it is to be understood that changes and variations may be made without departing from the spirit and scope of the appended claims.

What is claimed is:

1. An image forming apparatus that executes a job to form an image, comprising:
a job storage section to store job information including setting contents of the job in it;
a display section to display a screen in which a first area and a second area are disposed in such a manner that the first area and the second area do not overlap with each other; and
a control section to control contents to be displayed within the screen by the display section;
wherein the control section controls the display section, so that a job list based on the job information stored in the job storage section is displayed on the first area, and, at the same time, the setting contents of a specific job selected from the job list are displayed on the second area in parallel to the job list.

2. The image forming apparatus of claim 1,
wherein, when a predetermined operating button is selected in a state that the setting contents of the specific job are displayed on the second area, the control section implements a predetermined operation in regard to the specific job.

3. The image forming apparatus of claim 2,
wherein the predetermined operation is to change a priority order of the specific job.

4. The image forming apparatus of claim 2,
wherein the predetermined operation is to delete the specific job.

5. The image forming apparatus of claim 2,
wherein the predetermined operation is to enter the specific job into a pending state.

6. The image forming apparatus of claim 1,
wherein the setting contents of the specific job are displayed item by item within the second area in such a manner that each of setting items displayed on the second area also serves as an operating button; and
wherein, when the operating button is selected, the image forming apparatus enters into a state of accepting an operation for changing setting contents of the setting item corresponding to the selected operating button concerned.

7. The image forming apparatus of claim 6,
wherein the operation for changing setting contents is to release the setting contents of the setting item corresponding to the selected operating button concerned.

8. The image forming apparatus of claim 6,
wherein the setting contents of the specific job are classified into plural groups, so as to display the plural groups classified and titles of the plural groups, while correlating each of the plural groups to each of the titles.

9. The image forming apparatus of claim 2,
wherein the setting contents of the specific job, to be displayed on the second area, include at least information indicating a paper sheet feeding tray and other information of a paper sheet to be fed from the paper sheet feeding tray.
